(19) United States
(12) Patent Application Publication
(10) Pub. No.: US 2006/0198411 A1
(43) Pub. Date: Sep. 7, 2006

(54) Total reflecting cavity for a solid state laser

(76) Inventors: John E. Nettleton, Fairfax Station, VA (US); Bradley W. Schilling, Fredericksburg, VA (US); Dallas N. Barr, Woodbridge, VA (US)

Correspondence Address: DEPARTMENT OF THE ARMY;CECOM LEGAL OFFICE, FORT BELVOIR, AMSEL-LG-BELV, 10235 BURBECK ROAD, FORT BELVOIR, VA, 22060-5806, US

(21) Appl. No.: 11/071,215

(22) Filed: Mar. 4, 2005

(51) Int. Cl. H01S 3/16; H01S 3/091; H01S 3/092

(52) U.S. Cl. 372/41; 372/70

(57) ABSTRACT

A laser device in accordance with the present invention includes an enclosure that defines a pump cavity with a decreasing taper, from a maximum width at an input end to a minimum width at an output end of the cavity. A laser slab is positioned within the pump cavity by inserting the laser slab into a longitudinal slot that extends along the length of the enclosure. The longitudinal slot is in fluid communication with the pump cavity and the laser slab extends upwardly into the pump cavity once positioned therein. The internal opposing walls of the cavity are preferably gold-plated. Laser pump light is provided from the input end of the device. A portion of the input laser pump is received in the end of the laser slab. Other portions of the input pump light are received in the pump cavity, where they are reflected off the internal walls of the enclosure and into the sides of the laser slab, where they are converted into laser output.

### GOVERNMENT INTEREST

The invention described herein may be manufactured, used, sold, imported, and/or licensed by or for the Government of the United States of America.

### FIELD OF THE INVENTION

The present invention applies to devices for generating laser beams. More particularly, the present invention applies to laser generators that produce pulsed or continuous wave laser beams. The present invention is particularly, but not exclusively, useful as a laser having a pump cavity that manipulates an input pump beam to couple more efficiently into a solid state laser gain material. This will yield an output laser beam from the solid state gain material with greatly increased output power and efficiency relative to similarly sized devices without the input pump cavity device.

### BACKGROUND OF THE INVENTION

The use of laser devices for rangefinding or target designation purposes is well known in the prior art. To be effective, these devices should have certain desirable qualities. Specifically, these devices should be small, lightweight and easy to manufacture. Additionally, the devices should produce a pulsed laser beam that has good output power and a high pulse repetition rate that are suitable for ranging and designation operations.

Previous laser transmitters used in range finding and designation have had some, but not all, of these characteristics. For example, some flashlamp-pumped solid-state laser devices have been used to generate a laser beam of sufficient power for these purposes. However, although flashlamp-pumped lasers effectively generate a single laser pulse, they are not capable of being pulsed at a high pulse repetition rate without adding cumbersome cooling systems, which increases the size and power requirements of the laser transmitter.

Diode-pumped solid-state lasers lead to more efficient pulsed lasing operation and therefore are suitable for range finding and designation purposes, but they require additional optical components to efficiently couple the pump radiation into the solid state gain material. One way to increase the pump coupling in diode-pumped solid-state lasers is to collimate the input pump light before the input pump light enters the laser crystal. To do this, however, an arrangement of collimation lenses is required, and the added weight is an undesirable characteristic for the range finding/designation type of laser. Further, the incorporation of collimation lenses creates significant optical alignment issues that complicate the assembly process for the laser.

It so happens that by implementing the geometry of the laser pump cavity, the coupling efficiency of a solid-state diode-pumped laser device can be increased without using a lens arrangement to collimate input pump light. This obviates the additional weight and assembly disadvantages that are inherent when collimation optics are used with a diode-pumped, solid-state laser device. The geometry of the laser pump cavity can further decrease parasitic lasing within the gain material, which further results in greater lasing efficiency and greater output power for the laser device.

In view of the above, it is an object of the present invention to provide a diode-pumped laser device that can be used for rangefinding and designation purposes. It is another object of the present invention to provide a diode-pumped laser device which provides an output pulsed laser beam without requiring collimation of the input pump light. Another object of the present invention is to provide a diode-pumped laser device with a pump cavity having a predetermined geometry that further reduces parasitic laser modes within the gain material during operation thereof. Another object of the present invention is to provide a diode-pumped laser that is lightweight and battery-operated. Yet another object of the present invention is to design a laser which is easy to use, and which is comparatively cost-effective to manufacture.

### SUMMARY OF THE INVENTION

A laser device in accordance with the present invention includes a base, a pair of opposing walls that extend uprightly from said base and a cover that is placed on the opposing walls. The base, opposing walls and cover combine to form an enclosure for receiving a laser slab, and they further define a pump cavity for receiving pump light therein. The pump cavity has a decreasing taper, from a maximum width at the input end of the pump cavity to a minimum width at the output end of the cavity.

The lasing device of the present invention further includes the aforementioned laser slab, which is positioned within the pump cavity. To do this, a longitudinal slot is formed at the bottom of the enclosure, in the pallet. The longitudinal slot extends along the length of the enclosure in fluid communication with the pump cavity. The width of the longitudinal slot corresponds to a thickness of the laser slab, and the laser slab is inserted therein during assembly so that it extends upwardly from the longitudinal slot into the pump cavity.

The opposing walls of the cavity are plated with a material which is non-oxidizing and which is highly reflective of input pump light in the infrared range. In the preferred embodiment, the opposing walls are gold-plated. Laser pump light is provided from the input end of the device. A portion of the input laser pump is received in the laser slab input end. The remaining portion of the laser pump is received in the pump cavity. The input pump light is reflected off the gold-plated walls of the enclosure and into the sides of the laser slab, where it is absorbed by the gain material and thus contributes to the solid state laser output. In this manner, the input pump light is used more efficiently by the total reflecting cavity laser of the present invention.

### BRIEF DESCRIPTION OF THE DRAWINGS

The novel features of this invention will be best understood from the accompanying drawings, taken in conjunction with the accompanying description, in which similar characters refer to similar parts, and in which:

FIG. 1 is an exploded isometric view of the laser device of the present invention.

FIG. 2 is a cross-sectional view of the enclosure component of the laser taken along the line 2-2 of FIG. 1, with the cover removed.

FIG. 3 is a cross-sectional view of the enclosure component of the laser taken along the line 3-3 of FIG. 1, with the cover removed.

FIG. 4 is a top plan view of the enclosure component of the laser shown in FIG. 1, with the cover removed for clarity.

FIG. 5 is the same view as FIG. 2 but with the laser slab and cover for the enclosure in place.

FIG. 6 is the same view as FIG. 3, but with the laser slab and cover for the enclosure in place.

FIG. 7 is a top plan view of the device of FIG. 1 with the cover removed, in order to illustrate exemplary input pump light paths for the device.

### WRITTEN DESCRIPTION OF THE PREFERRED EMBODIMENT

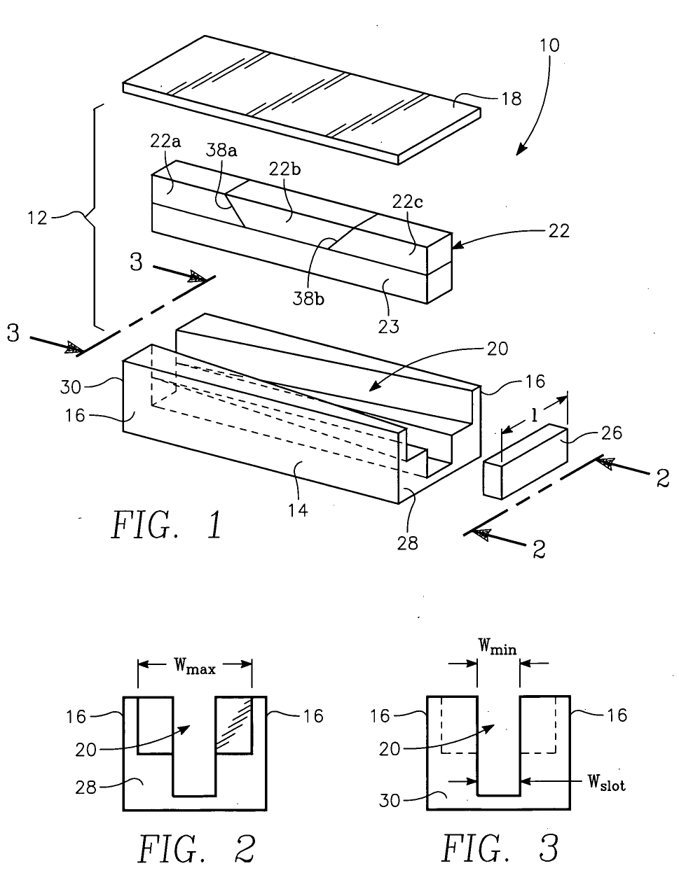

Referring initially to FIG. 1, the laser device of the present invention is shown and is generally designated by reference character 10. As shown, the device includes a base 14, which merges into a pair of opposing walls 16, 16 that extend uprightly therefrom. A cover 18 rests on the opposing walls, and the base, opposing walls and cover cooperate to form enclosure 12. The enclosure further defines a pump cavity 20, and a laser slab 22 is positioned in the pump cavity 20. The laser slab consists of Brewster cut gain material blocks 22a, 22b, 22c and a supporting pallet 23 made from a thermal expansion matched material. For example the blocks 22a, 22b and 22c could be made from Nd:YAG and the pallet 23 could be YAG. The laser slab and pump cavity receive input pump light (denoted by arrows 24 in FIG. 7) from a pump light source 26. The input pump light is processed within the pump cavity in a manner more fully described hereinafter.

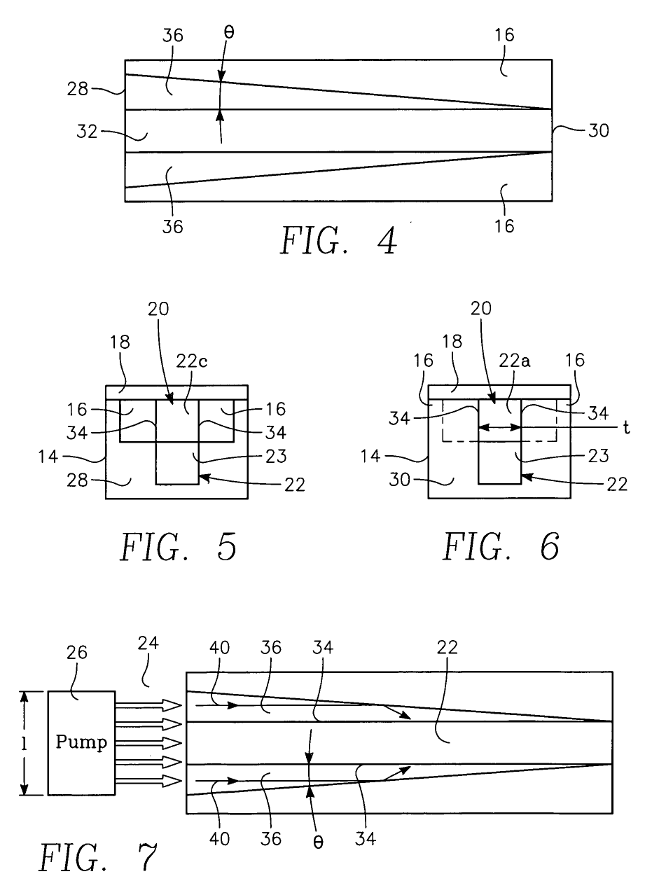

Referring now to FIGS. 1-7, the geometry of the enclosure is described more fully. The enclosure has an input end 28 and an opposing output end 30, and the aforementioned opposing walls define a pump cavity 20 which has a decreasing taper from input end 28 to output end 30. More specifically, the pump cavity tapers from a maximum width wₘₐₓ at input end 28 that matches the length l of the diode laser pump dimension, to a minimum width wₘᵢₙ at output end 30 that is nominally the thickness t of the laser slab, as shown in the Figures. This structure further establishes a pair of ledges 36, which appear to be triangular when viewed in top plan, and perhaps best seen in FIGS. 4 and 7.

To facilitate assembly of the device, the base 14 is formed with a longitudinal slot 32. The longitudinal slot extends along the length of the enclosure in fluid communication with the pump cavity. Preferably, the slot has a uniform slot width wₛₗₒₜ that is equal to wₘᵢₙ, and wₛₗₒₜ also corresponds to the thickness t of the laser slab 22 (See FIGS. 5 and 6). The depth of longitudinal slot 32 and the dimensions of the laser slab (which is preferably rectangular) are chosen so that the laser slab extends upwardly into the pump cavity once it is inserted into longitudinal slot and fixed to the base, as perhaps best seen in FIGS. 5 and 6.

In the preferred embodiment, the opposing walls are coated with a material that is highly reflective in wavelength range at which the pump is emitted by the pump source. For a diode pump, the opposing walls are preferably coated with a material which is highly reflective in the infrared spectrum range, and further which does not oxidize. Preferably, the opposing walls are gold-plated in a manner well known in the art. Only the opposing walls and the internal surfaces of the pump cavity need be coated to practice the present invention, although in practice, it is actually easier to gold-plate all of the surfaces of the enclosure simultaneously.

The monolithic nature of the device is important in that the laser slab blocks 22a, 22b, 22c, supporting laser pallet 23, and cover 18, encompassing the pump cavity 20 and other components mentioned above are mounted directly to the base 14, without requiring the use of optical holders. The manner in which this is accomplished is described more fully in U.S. Pat. No. 6,373,865 by John E. Nettleton et al., entitled “Pseudo-Monolithic Laser With An Intracavity Optical Parametric Oscillator”, which is assigned to the same assignee as this patent application and which is incorporated herein by reference.

The gain material in the laser slab 22a, 22b and 22c, is preferably made of a Neodymium doped Yttrium Aluminum Garnet (Nd:YAG) crystal that is doped to between zero and five percent (0-5%). However, it is understood that other materials could also be used for the doped rectangular prism portion, such as Neodymium Doped Yttrium Orthovanadate (Nd:YVO4), Neodymium Doped Yttrium Lithium Fluoride Nd:YLF and Neodymium Doped YAlO3 Perovskite (Nd:YAP) or doped glass materials. The pallet 23 would then be fabricated from an undoped material that is thermally compatible as described above. The input end 28 and output end 30 are coated with reflective or antireflective coatings for diode laser pumping and lasing operations in a manner well known in the art.

As shown in FIG. 1, a Brewster cut 38a and 38b can be made in the laser slab, and angled from the vertical in order to polarize the laser output in a manner known in the art. Because of the above-described palletized nature of the device, the Brewster cuts can divide laser slab 22 gain material into the aforementioned blocks 22a, 22b and 22c yet the overall assembly of the device remains relatively simple. This is because the blocks 22a, 22b, 22c can easily be attached onto pallet 23 as described above. Moreover, the segmented configuration would allow for combination of laser slab blocks 22a, 22b, 22c that are made of different materials. For example, block 22a could be made of a Nd:YAP material while block 22b could be made of a Nd:YVO4 material. Or, the materials for blocks 22a, 22b, 22c could be made of the same material but the doping percentages cited above could be changed for each block.

The operation of the device can be shown and described in greater detail by referring to FIG. 7. When pump cavity 20 is configured as described above, input pump light from the pump light source 26 is reflected internally off opposing walls 16, 16 of the enclosure into side surfaces 34, 34 of the laser slab 22. To ensure that the reflection occurs, and to minimize parasitic lasing within the laser slab, the opposing walls should be oriented at a maximum angle θ with respect to side surfaces 34, 34 of laser slab 22. The angle θ is normally set by the dimensions of the pump cavity length, and respective widths wₘₐₓ and wₘᵢₙ. In the preferred embodiment, angle θ is less than twenty degrees (0<θ<20°).

While the total reflective cavity for a solid state laser, as herein shown and disclosed in detail, is fully capable of obtaining the objectives and providing the advantages above stated, it is to be understood that the presently preferred embodiments are merely illustrative of the invention. As such, no limitations are intended other than as defined in the appended claims.

What is claimed is:

1. A lasing device comprising:
an enclosure having an input end, an output end and a pair of opposing walls;
said opposing walls defining a pump cavity having a decreasing taper from a maximum width at said input end to a minimum width at said output end; and,
a laser slab positioned in said pump cavity, said walls being positioned to reflect input pump light into said laser slab.

2. The device of claim 1 wherein said enclosure has a longitudinal slot in fluid communication with said pump cavity, said laser slab being inserted into said longitudinal slot.

3. The device of claim 1 wherein said opposing walls are plated with a non-oxidizing material which is highly reflective of infrared pump light.

4. The device of claim 3 wherein said non-oxidizing material is gold.

5. The device of claim 1 wherein said laser slab is made of a doped material chosen from the group consisting of Nd:YAG, Nd:YVO4, Nd:YLF and Nd:YAP.

6. The device of claim 5 wherein said laser slab further includes at least one Brewster cut extending at least partially therethrough.

7. The device of claim 1 wherein said minimum width is about half of said maximum width.

8. The device of claim 7 wherein said laser slab has a thickness and said thickness is equal to said minimum width.

9. A laser apparatus comprising:
a rectangular laser slab having an input end and an output end and parallel side surfaces;
an enclosure surrounding said laser slab; and,
said enclosure having a pair of opposing walls extending outward from said side surfaces of said laser slab at an angle θ for reflecting input pump light into said laser slab.

10. The laser apparatus of claim 9 wherein said laser slab is formed with a longitudinal slot and said laser slab is inserted into said longitudinal slot.

11. The laser apparatus of claim 9 wherein said opposing walls are coated with a non-oxidizing material that is highly reflective of infrared pump light.

12. The laser apparatus of claim 11 wherein said non-oxidizing material is gold.

13. The laser apparatus of claim 9 wherein said laser slab is chosen from the group consisting of Nd:YAG, Nd:YVO4, Nd:YLF and Nd:YAP.

14. The laser apparatus of claim 9 wherein said angle θ is between zero and twenty degrees (0<θ<20).

15. A method for a thermal lasing comprising the steps of:
A) providing a block;
B) forming a pump cavity in said block, said pump cavity having a maximum width at an input end of said block, said pump cavity further having a decreasing taper to a minimum width at the opposing output end of said block;
C) providing a first rectangular prism made of doped lasing material;
D) pumping input pump light into said input end of said pump cavity; and,
E) positioning a rectangular laser slab in said cavity so that said input light reflects off said opposing walls into said laser slab.

16. The method of claim 15 further comprising the step of:
F) coating said opposing Walls with a metallic material.

17. The method of claim 16 further comprising the steps of:
G) affording a longitudinal slot in said block said longitudinal slot in fluid communication with said pump cavity, and;
H) inserting said laser slab into said longitudinal slot.

18. The method of claim 15 wherein said step B) is accomplished with a material selected from the group consisting of Nd:YAG, Nd:YVO4, Nd:YLF and Nd:YAP.

19. A laser comprising:
a base;
a laser slab mounted to said base;
a pair of opposing walls extending upright from said base, said laser slab being positioned between said opposing walls;
a cover resting on said opposing walls, said base, opposing walls and cover cooperating to define a pump cavity; and,
said pump cavity having a decreasing taper from a maximum width at one end of said laser slab minimum width the other end of said laser slab.

20. The laser of claim 19 further comprising a longitudinal slot in said base, said longitudinal slot in fluid communication with said pump cavity, said laser slab inserted into said longitudinal slot.
